(19) United States
(12) Patent Application Publication
(10) Pub. No.: US 2012/0144245 A1
(43) Pub. Date: Jun. 7, 2012

(54) COMPUTING DEVICE AND METHOD FOR DETECTING PCI SYSTEM ERRORS IN THE COMPUTING DEVICE

(75) Inventors: CUN-HUI FAN, Shenzhen City (CN); JIAN PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/305,755

(22) Filed: Nov. 29, 2011

(30) Foreign Application Priority Data
Dec. 3, 2010 (CN) 201010572389.9

(51) Int. Cl. G06F 11/20

(52) U.S. Cl. 714/43; 714/E11.079

(57) ABSTRACT

A method for detecting peripheral component interconnect (PCI) system errors is applied in a computing device. The computing device includes a north bridge, a baseboard management controller (BMC) connected to the north bridge, and a PCI bus connected to the north bridge. The north bridge detects a PCI system error of the PCI bus, and notifies the BMC of the PCI system error. In response to notification of the PCI system error, the BMC records error information of the PCI system error in a storage system of the computing device.

### BACKGROUND

1. Technical Field

Embodiments of the present disclosure relate to peripheral component interconnect (PCI) error detection, and particularly to a computing device and a method for detecting PCI system errors in the computing device.

2. Description of Related Art

There are two types of peripheral component interconnect (PCI) errors in a computing device: PCI parity error and PCI system error. A PCI parity error may occur when a PCI transaction suffers corruption. Several PCI parity errors may result in a PCI system error. The PCI system errors can be detected by a basic input/output system (BIOS) of the computing device at startup of the computing device. After the computing device has started, the BIOS cannot detect the PCI system errors.

### BRIEF DESCRIPTION OF THE DRAWINGS

FIG. 1 is a block diagram of one embodiment of a computing device.

FIG. 2 is a block diagram of one embodiment of a north bridge included in the computing device of FIG. 1.

FIG. 3 is a block diagram of one embodiment of a BMC included in the computing device of FIG. 1.

FIG. 4 is a flowchart of one embodiment of a method for detecting PCI system errors in a computing device.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

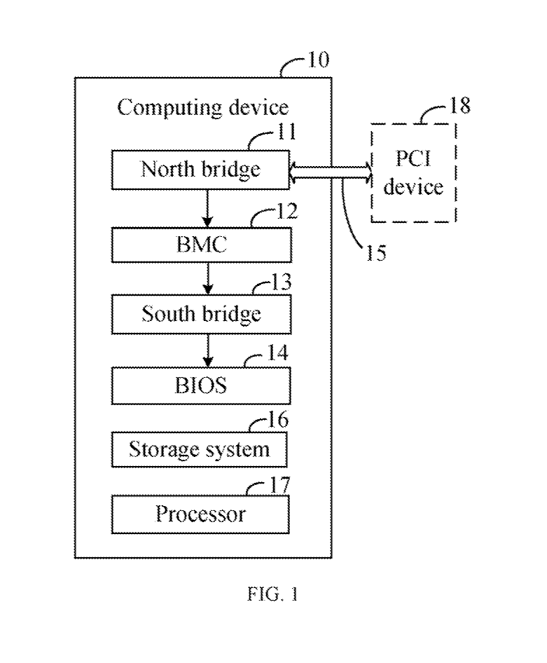

FIG. 1 is a block diagram of one embodiment of a computing device 10. In one embodiment, the computing device 10 includes a north bridge 11, a baseboard management controller (BMC) 12, a south bridge 13, a basic input/output system (BIOS) 14, a peripheral component interconnect (PCI) bus 15, a storage system 16, and at least one processor 17. The BMC 12 is connected to the north bridge 11 and the south bridge 13. The PCI bus 15 connects the north bridge 11 to one or more peripheral PCI devices 18 (only one is shown in FIG. 1). The south bridge 13 is further connected to the BIOS 14. A PCI parity error may occur when data transfer over the PCI bus 15 suffers corruption. Several PCI parity errors may result in a PCI system error. The computing device 10 may be a computer or a server, for example.

Each of the north bridge 11 and the BMC 12 includes a number of function modules, for detecting the PCI system errors in the computing device 10 after the computing device 10 has started. The function modules may comprise computerized codes in the form of one or more programs that are stored in the storage system 16. The computerized codes includes instructions that are executed by the at least one processor 17 to provide functions for the modules. In one embodiment, the storage system 16 may be an internal storage device, such as a random access memory (RAM) for temporary storage of information, and/or a read only memory (ROM) for permanent storage of information. In some embodiments, the storage system 16 may also be an external storage device, such as an external hard disk, a storage card, or other data storage medium.

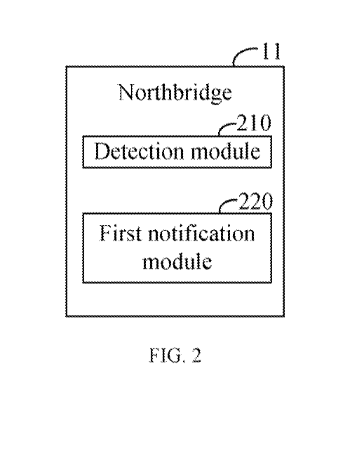

FIG. 2 is a block diagram of one embodiment of the north bridge 11 included in the computing device 10 of FIG. 1. In one embodiment, the north bridge 11 includes a detection module 210 and a first notification module 220.

The detection module 210 detects a PCI system error of the PCI bus 15. In one embodiment, a specific register of the computing device 10 is assigned to record a status of the PCI bus 15. For example, if no PCI system error occurs, a digital number “0” is written to the register. If a PCI system error occurs, a digital number “1” is written to the register. The detection module 210 detects the PCI system error according to the register.

The first notification module 220 notifies the BMC 11 of the PCI system error. In one embodiment, the first notification module 220 generates a first signal and outputs the first signal to the BMC 12 to indicate the PCI system error is detected. In one example, the first notification module 220 generates a high level signal, such as a 5V signal, to notify the BMC 11 of the PCI system error. The first signal may be a general purpose input/output (GPIO) signal.

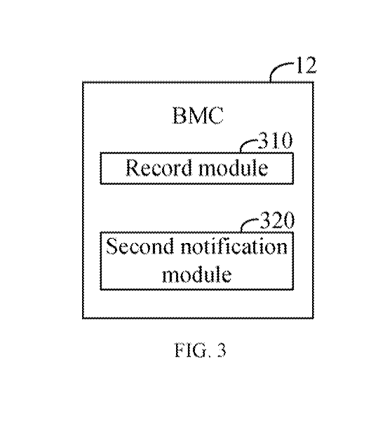

FIG. 3 is a block diagram of one embodiment of the BMC 12 included in the computing device 10 of FIG. 1. In one embodiment, the BMC 12 includes a record module 310 and a second notification module 320.

The record module 310 records error information of the PCI system error in the BMC 11 when the BMC 11 is notified of the PCI system error. For example, if the BMC 12 receives the high level signal from the north bridge 11, which indicates that the PCI system error is detected, the record module 310 records error information of the PCI system error in the storage system 16. The error information may include time of the PCI system error and a PCI device 18 related to the PCI system error.

The second notification module 320 notifies the BIOS 14 of the PCI system error. In one embodiment, the second notification module 320 triggers a system management interrupt (SMI) to the south bridge 13. The BIOS 14 detects the SMI from the south bridge 13 to identify the PCI system error. In the embodiment, the second notification module 320 generates a second signal, such as a 0V signal, to trigger the SMI to the south bridge 13. The BIOS 14 may record the error information of the PCI system error in a system log of the computing device 10 upon notification of the PCI system error. The system log is stored in the storage system 16 of the computing device 10.

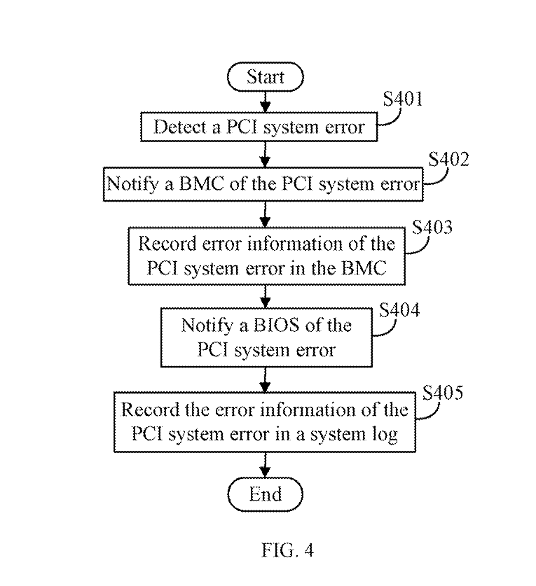

FIG. 4 is a flowchart of one embodiment of a method for detecting PCI system error in a computing device, such as that of FIG. 1. Depending on the embodiments, additional blocks may be added, others removed, and the ordering of the blocks may be changed.

In block S401, the detection module 210 detects a PCI system error of the PCI bus 15.

In block S402, the first notification module 220 notifies the BMC 11 of the PCI system error. In one embodiment, the first notification module 220 outputs a first signal to the BMC 12 to indicate that the PCI system error is detected.

In block S403, the record module 310 records error information of the PCI system error in the BMC 11 when the BMC 11 is notified of the PCI system error.

In block S404, the second notification module 320 notifies the BIOS 14 of the PCI system error. In one embodiment, the second notification module 320 triggers a SMI to the south bridge 13 to notify the BIOS of the PCI system error. The second notification module 320 may generate a second signal to trigger the SMI to the south bridge 13.

In block S405, the BIOS 14 records the error information of the PCI system error in a system log of the computing device 10. In one embodiment, the system log of the computing device 10 may be stored in the storage system 16.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a baseboard management controller (BMC) comprising a detection module and a first notification module;
a north bridge connected to the BMC, the north bridge comprising a record module and a second notification module;
a peripheral component interconnect (PCI) bus connected to the north bridge; and
a storage system; wherein:
the detection module is operable to detect a PCI system error of the PCI bus;
the first notification module is operable to notify the BMC of the PCI system error; and
the record module is operable to record error information of the PCI system error in the storage system in response to notification of the PCI system error from the north bridge.

2. The computing device of claim 1, wherein the first notification module generates a first signal and outputs the first signal to the BMC to indicate the PCI system error is detected.

3. The computing device of claim 1, wherein the computing device further comprises a basic input/output system (BIOS) that is connected to the BMC, and a south bridge that is connected to the north bridge and the BIOS.

4. The computing device of claim 3, wherein the BMC further comprises a second notification module operable to notify the BIOS of the PCI system error by triggering a system management interrupt (SMI) to the south bridge.

5. The computing device of claim 4, wherein the SMI is triggered by generating a second signal.

6. The computing device of claim 3, wherein the BIOS records the error information of the PCI system error in a system log of the computing device.

7. A method for detecting peripheral component interconnect (PCI) system errors in a computing device, the method comprising:
detecting a PCI system error of a PCI bus in the computing device by a north bridge of the computing device, wherein the PCI bus is included in the computing device and connected to the north bridge;
notifying the BMC of the PCI system error by the north bridge; and
recording error information of the PCI system error by a baseboard management controller (BMC) in response to notification of the PCI system error, wherein the BMC is included in the computing device and connected to the north bridge.

8. The method of claim 7, wherein the north bridge notifies the BMC of the PCI system error by generating a first signal and outputting the first signal to the BMC.

9. The method of claim 7, wherein the computing device further comprises a basic input/output system (BIOS) that is connected to the BMC, and a south bridge that is connected to the north bridge and the BIOS.

10. The method of claim 9, further comprising:
notifying the BIOS of the PCI system error by the BMC by triggering a system management interrupt (SMI) to the south bridge.

11. The method of claim 10, wherein the SMI is triggered by generating a second signal.

12. The method of claim 9, further comprising:
recording the error information of the PCI system error in a system log of the computing device by the BIOS.

13. A non-transitory computer-readable medium having stored thereon instructions that, when executed by a processor of a computing device, causes the processor to execute a method for detecting peripheral component interconnect (PCI) system errors in the computing device, the method comprising:
detecting a PCI system error of a PCI bus in the computing device by a north bridge of the computing device, wherein the PCI bus is included in the computing device and connected to the north bridge;
notifying the BMC of the PCI system error by the north bridge; and
recording error information of the PCI system error by a baseboard management controller (BMC) in response to notification of the PCI system error, wherein the BMC is included in the computing device and connected to the north bridge.

14. The medium of claim 13, wherein the north bridge notifies the BMC of the PCI system error by generating a first signal and outputting the first signal to the BMC.

15. The medium of claim 13, wherein the computing device further comprises a basic input/output system (BIOS) that is connected to the BMC, and a south bridge that is connected to the north bridge and the BIOS.

16. The medium of claim 15, wherein the method further comprises:
notifying the BIOS of the PCI system error by the BMC by triggering a system management interrupt (SMI) to the south bridge.

17. The medium of claim 16, wherein the SMI is triggered by generating a second signal.

18. The medium of claim 15, wherein the method further comprises:
recording the error information of the PCI system error in a system log of the computing device by the BIOS.
